(19) United States
(12) Patent Application Publication
(10) Pub. No.: US 2022/0396163 A1
(43) Pub. Date: Dec. 15, 2022

(54) MOTOR UNIT AND MOTOR CONTROL SYSTEM

(71) Applicant: NIDEC CORPORATION, Kyoto (JP)

(72) Inventors: Akihiro NITA, Kyoto (JP); Peng XIONG, Kyoto (JP)

(21) Appl. No.: 17/775,314

(22) PCT Filed: Sep. 14, 2020
(86) PCT No.: PCT/JP2020/034770

§ 371 Date: May 9, 2022

(30) Foreign Application Priority Data
Nov. 15, 2019 (JP) 2019-207345

(51) Int. Cl. B60L 53/22; B60L 1/00; H02P 5/74

(52) U.S. Cl. CPC B60L 53/22; B60L 1/003; H02P 5/74

(57) ABSTRACT

A motor unit including: a first motor that drives a vehicle; a second motor that drives an auxiliary machine of the first motor; a first inverter that controls the first motor in response to a control signal transmitted from a main control device of the vehicle; and a second inverter that controls the second motor in response to a drive command signal for controlling the second motor transmitted from the first inverter, in which the second inverter transitions to an operation state of suppressing power consumption of the second inverter when reception of the drive command signal is finished.

### CROSS-REFERENCE TO RELATED APPLICATIONS

This is the U.S. national stage of application No. PCT/JP2020/034770, filed on Sep. 14, 2020, and priority under 35 U.S.C. § 119 (a) and 35 U.S.C. § 365 (b) is claimed from Japanese Patent Application No. 2019-207345, filed on Nov. 15, 2019.

### FIELD OF THE INVENTION

The present invention relates to a motor unit and a motor control system.

The present application claims priority based on Japanese Patent Application No. 2019-207345 filed in Japan on Nov. 15, 2019, the contents of which are incorporated herein by reference.

### BACKGROUND

In recent years, electric vehicles, hybrid vehicles, and the like using a motor unit as a drive source have begun to spread as environmentally friendly vehicles. These electric vehicles and the like are each equipped with an inverter device that converts DC power from a battery into AC power to be supplied to a motor, and controls driving torque and the like to accelerate or decelerate the vehicle.

Conventionally, there is known a motor unit that includes a motor that drives a vehicle, an inverter unit that controls the motor unit, and an auxiliary machine such as a pump that cools the motor unit. It is conventionally known that a dark current is generated in a traveling motor or an inverter that controls an auxiliary machine while a vehicle is stopped or when a power source of the vehicle is turned off. The dark current is power consumed by a control system that controls an electric motor when the power supply of the vehicle is turned off. The conventional motor unit includes a second inverter to reduce a load, the second inverter being provided separately from an inverter that controls the motor unit, and the second inverter controls the auxiliary machine such as a pump.

However, the conventional motor unit has a problem in that control of the second inverter is difficult when the vehicle is stopped, parked, or the like because a first inverter and the second inverter are independently supplied with power from a battery.

### SUMMARY

An exemplary motor unit according to an aspect of the present invention includes: a first motor that drives a vehicle; a second motor that drives an auxiliary machine of the first motor; a first inverter that controls the first motor in response to a control signal transmitted from a main control device of the vehicle; and a second inverter that controls the second motor in response to a drive command signal for controlling the second motor transmitted from the first inverter, in which the second inverter transitions to an operation state of suppressing power consumption of the second inverter when reception of the drive command signal is finished.

An exemplary motor control system according to another aspect of the present invention controls a first motor that drives a vehicle and a second motor that drives an auxiliary machine of the first motor, the motor control system including: a first inverter that controls the first motor in response to a control signal transmitted from a main control device of the vehicle; and a second inverter that controls the second motor in response to a drive command signal transmitted from the first inverter for controlling the second motor, in which the second inverter transitions to an operation state of suppressing power consumption of the second inverter when reception of the drive command signal is finished.

The above and other elements, features, steps, characteristics and advantages of the present disclosure will become more apparent from the following detailed description of the preferred embodiments with reference to the attached drawings.

### BRIEF DESCRIPTION OF THE DRAWINGS

FIG. 1 is a diagram schematically showing an example of a configuration of a motor unit;

FIG. 2 is a diagram schematically showing an example of a block configuration of a pump inverter;

FIG. 3 is a flowchart showing an example of an operation flow in a driving inverter;

FIG. 4 is a flowchart showing an example of an operation flow in the pump inverter;

FIG. 5 is a diagram showing an example of various changes when an ignition switch is turned on and off; and

FIG. 6 is a diagram schematically showing an example of a configuration of a motor unit.

### DETAILED DESCRIPTION

Although the present invention will be described below through a preferred embodiment of the invention, the preferred embodiment below does not limit the invention according to the claims. All combinations of features described in the preferred embodiment are not necessarily essential to the solution of the invention.

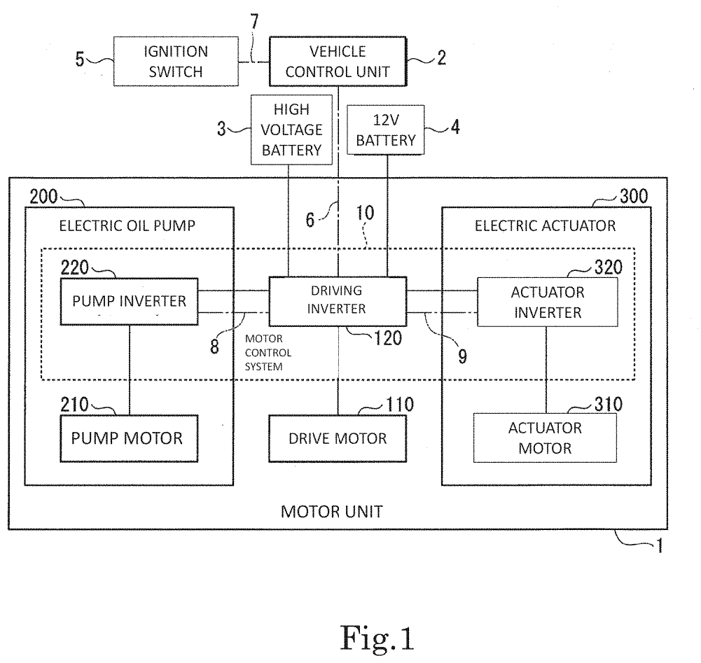

FIG. 1 schematically shows an example of a configuration of a motor unit 1. In FIG. 1, solid lines that connect respective configurations indicate power supply lines. In FIG. 1, alternate long and short dash lines that connect respective configurations indicate signal lines.

The motor unit 1 includes a drive motor 110, a driving inverter 120, an electric oil pump 200, and an electric actuator 300. The drive motor 110 is an example of a “first motor”. The driving inverter 120 is an example of a “first inverter”. The electric oil pump 200 and the electric actuator 300 are each an example of an “auxiliary machine of the first motor”.

The drive motor 110 drives an electric vehicle. The electric vehicle travels using electricity as an energy source and the drive motor 110 as a power source. The electric vehicle in the present preferred embodiment will be described as a secondary battery-type electric vehicle, for example, in which a secondary battery chargeable by connecting an electric plug to a vehicle body is used as a source, and the drive motor 110 is rotated by electricity of the secondary battery. The electric vehicle is an example of a “vehicle”.

The driving inverter 120 controls the drive motor 110 in response to a control signal transmitted from a vehicle control unit 2 of the electric vehicle. The driving inverter 120 receives the control signal from the vehicle control unit 2 via a controller area network (CAN) bus. The vehicle control unit 2 controls the entire electric vehicle. For example, when receiving an ignition signal from an ignition switch 5 through a signal line 7, the vehicle control unit 2 transmits the ignition signal to the driving inverter 120 via the CAN bus 6. The ignition switch 5 is a device for starting the drive motor 110. Then, the driving inverter 120 converts a direct current supplied from a high voltage battery 3 into an alternating current and controls rotation of the drive motor 110. The vehicle control unit 2 is an example of a “vehicle main control device”.

The electric oil pump 200 is operated by a motor. The electric oil pump 200 includes a pump motor 210 and a pump inverter 220. The pump motor 210 is an example of a “second motor”. The pump inverter 220 is an example of a “second inverter”.

The pump motor 210 drives the electric oil pump 200.

The pump inverter 220 controls the pump motor 210 in response to a drive command signal for controlling the pump motor 210 transmitted from the driving inverter 120. The pump inverter 220 receives the drive command signal from the driving inverter 120 through a signal line 8 different from the CAN bus 6. The pump inverter 220 then converts a direct current supplied from a 12V battery 4 through the driving inverter 120 into an alternating current, and controls rotation of the pump motor 210.

The electric actuator 300 operates a parking lock mechanism. The electric actuator 300 includes an actuator motor 310 and an actuator inverter 320. The actuator motor 310 is an example of the “second motor”. The actuator inverter 320 is an example of the “second inverter”.

The actuator motor 310 drives the electric actuator 300.

The actuator inverter 320 controls the actuator motor 310 in response to the drive command signal for controlling the actuator motor 310 transmitted from the driving inverter 120. The actuator inverter 320 receives the drive command signal from the driving inverter 120 through a signal line 9 different from the CAN bus 6. The actuator inverter 320 then converts a direct current supplied from the 12V battery 4 through the driving inverter 120 into an alternating current, and controls rotation of the actuator motor 310.

The driving inverter 120, the pump inverter 220, and the actuator inverter 320 are each an example of a “motor control system”.

Here, the driving inverter 120 can perform control for suppressing a dark current at appropriate timing in response to the control signal transmitted from the vehicle control unit 2 via the CAN bus 6.

In contrast, the pump inverter 220 and the actuator inverter 320 are not connected to the CAN bus 6, and thus cannot perform the control for suppressing the dark current in response to the control signal transmitted from the vehicle control unit 2.

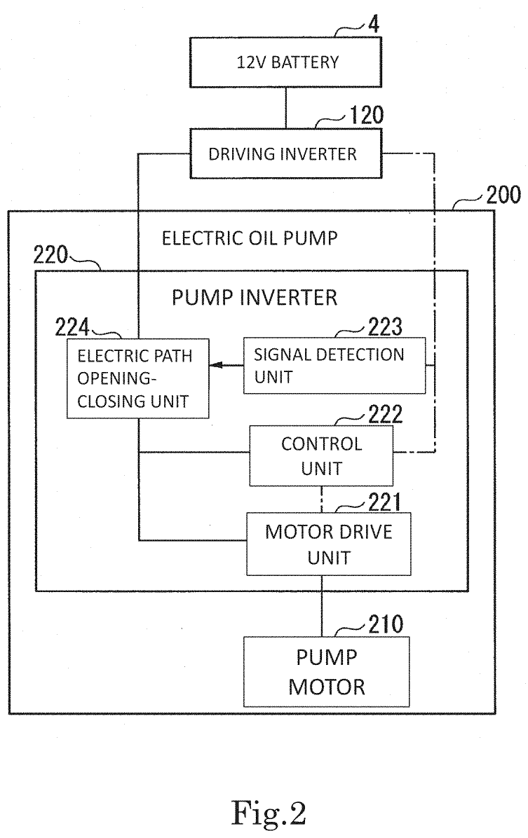

Then, when reception of the drive command signal transmitted from the driving inverter 120 is finished, the pump inverter 220 transitions to an operation state in which some circuits are stopped to suppress power consumption of the pump inverter 220. Here, some circuits are, for example, a circuit that drives the pump motor 210 (motor drive unit 221 shown in FIG. 2), a microcomputer that generates a PWM signal for rotationally driving the pump motor 210 (control unit 222 shown in FIG. 2), and the like. Similarly, when the reception of the drive command signal transmitted from the driving inverter 120 is finished, the actuator inverter 320 stops some circuits and transitions to an operation state of suppressing power consumption of the actuator inverter 320.

FIG. 2 schematically shows an example of a block configuration of the pump inverter 220. The pump inverter 220 includes the motor drive unit 221, the control unit 222, a signal detection unit 223, and an electric path opening-closing unit 224.

The motor drive unit 221 is a circuit that drives the pump motor 210. The motor drive unit 221 converts a direct current supplied through the driving inverter 120 into a three-phase alternating current having a frequency according to the PWM signal output from the control unit 222, and outputs the three-phase alternating current to the pump motor 210.

The control unit 222 is a microcomputer that controls the motor drive unit 221. The control unit 222 generates a pulse width modulation (PWM) signal for rotationally driving the pump motor 210 at a frequency based on the PWM of the drive command signal transmitted from the driving inverter 120. Then, the control unit 222 outputs the generated PWM signal to the motor drive unit 221.

The signal detection unit 223 is a circuit that detects whether the drive command signal is received. The signal detection unit 223 is supplied with power of 5 V through a step-down switching regulator (not shown) provided upstream of the electric path opening-closing unit 224. Thus, the signal detection unit 223 is also operable when the electric path opening-closing unit 224 is turned off.

The electric path opening-closing unit 224 is a switch circuit that switches on and off of an electric path for supplying electric power to the motor drive unit 221 and the control unit 222.

The actuator inverter 320 has a block configuration similar to that of the pump inverter 220.

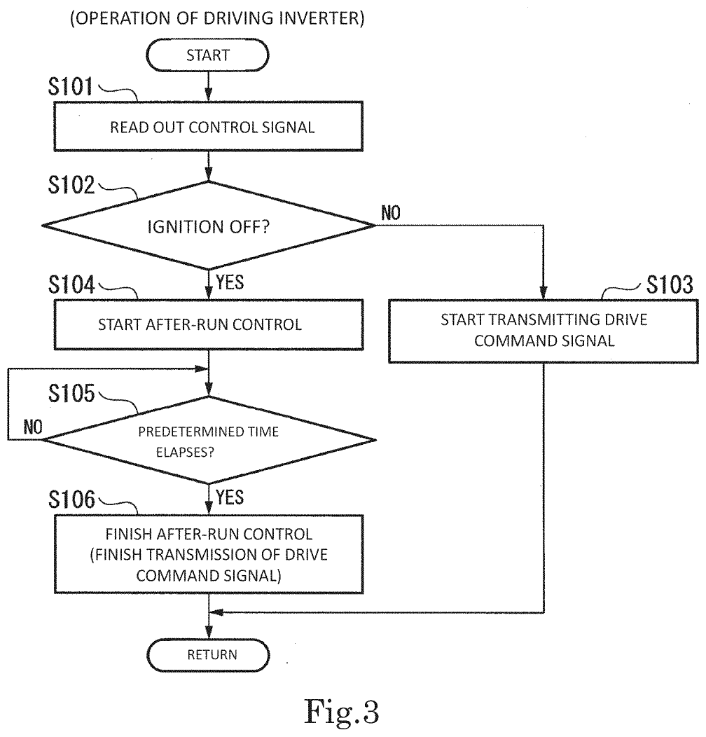

FIG. 3 shows an example of an operation flow in the driving inverter 120. FIG. 3 shows a processing flow from start to end of the drive command signal for the pump inverter 220.

The driving inverter 120 reads out the control signal transmitted from the vehicle control unit 2 via the CAN bus 6 every predetermined time (step S101).

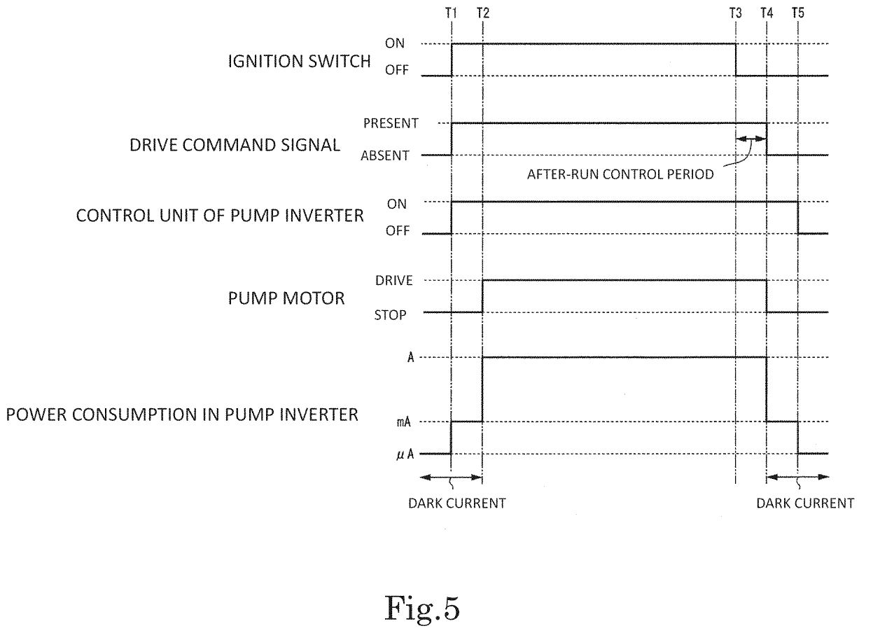

When the control signal indicating turning on of the ignition is readout in step S101 (NO in step S102), the driving inverter 120 transmits the drive command signal (step S103) to finish the processing shown in FIG. 3. For example, when the processing in step S103 is performed in a situation where the drive command signal is not transmitted, the driving inverter 120 starts transmitting the drive command signal (timing T1 in FIG. 5). For example, when the processing in step S103 is performed in a situation where the drive command signal is being transmitted, the driving inverter 120 continues to transmit the drive command signal (a period from timing T1 to timing T3 in FIG. 5).

Upon receiving the drive command signal, the pump inverter 220 controls driving of the pump motor 210.

In contrast, when the control signal indicating turning off of the ignition is readout in step S101 (YES in step S103), the driving inverter 120 starts after-run control (step S104, timing T3 in FIG. 5). In step S104, the driving inverter 120 sets a timer for measuring a predetermined time until the transmission of the drive command signal is stopped.

After step S104, the driving inverter 120 refers to a value of the timer and waits until the predetermined time elapses (NO in step S105). The driving inverter 120 continues to transmit the drive command signal even during a period in which the after-run control is performed (a period from timing T3 to timing T4 in FIG. 5).

Then, when the predetermined time elapses after step S104 (YES in S105), the driving inverter 120 finishes the after-run control (step S106) to finish the processing shown in FIG. 3. In step S106, the driving inverter 120 finishes transmitting the drive command signal (timing T4 in FIG. 5).

The pump inverter 220 does not control driving of the pump motor 210 unless receiving the drive command signal.

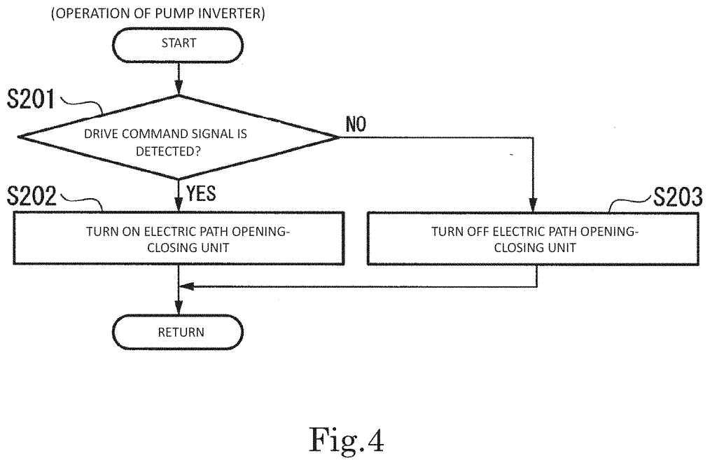

FIG. 4 shows an example of an operation flow in the pump inverter 220. FIG. 4 shows a processing flow from when the electric path opening-closing unit 224 is switched on to when it is switched off. This flow is performed by detecting whether the drive command signal is received.

The electric path opening-closing unit 224 is turned on (step S202, a period from timing T2 to timing T4 in FIG. 5) when the signal detection unit 223 detects the drive command signal (YES in step S201).

The electric path opening-closing unit 224 is turned off (step S203) when the signal detection unit 223 detects no drive command signal (NO in step S201).

Thus, the electric path opening-closing unit 224 is switched from off to on when the signal detection unit 223 detects a start of reception of the drive command signal (timing T1 in FIG. 5). The electric path opening-closing unit 224 is switched from on to off when the signal detection unit 223 detects an end of reception of the drive command signal. When the signal detection unit 223 detects the end of reception of the drive command signal, the electric path opening-closing unit 224 may be immediately turned off, or may be turned off when a predetermined time elapses. When the electric path opening-closing unit 224 is configured to be immediately turned off, the pump inverter 220 can be maintained for a long time in a state of suppressing the dark current. In contrast, when the electric path opening-closing unit 224 is configured to be turned off when the predetermined time elapses, a period can be secured for the control unit 222 to perform processing for shifting to a sleep state.

FIG. 5 shows an example of various changes when the ignition switch 5 is turned on and off. FIG. 5 shows an example in which when the signal detection unit 223 detects the end of reception of the drive command signal, the electric path opening-closing unit 224 is turned off when a predetermined time elapses.

When the ignition switch 5 is turned off, the driving inverter 120 transmits no drive command signal. The pump inverter 220 is configured such that when the signal detection unit 223 detects no drive command signal, the electric path opening-closing unit 224 is turned off to supply no power to the motor drive unit 221 and the control unit 222. The control unit 222 is in an OFF state due to no power supply. Thus, the pump motor 210 is stopped. At this time, the pump inverter 220 has a power consumption by operation of the signal detection unit 223, and the power consumption has a magnitude expressed in units of several μA, for example.

When the ignition switch 5 is turned from off to on (timing T1), the driving inverter 120 starts the transmission of the drive command signal. The pump inverter 220 is configured such that when the signal detection unit 223 detects the start of reception of the drive command signal, the electric path opening-closing unit 224 is turned on to start power supply to the motor drive unit 221 and the control unit 222. When the control unit 222 is supplied with power, it falls in an ON state where it is operable. However, a predetermined time is required to start processing of generating the PWM signal. Thus, the pump motor 210 is stopped. At this time, the pump inverter 220 has a power consumption to which a power consumption by operation of the control unit 222, which does not control the pump motor 210, is added, and the power consumption has a magnitude expressed in units of several mA, for example.

When the ignition switch 5 is turned on and a predetermined time elapses (timing T2), the control unit 222 starts the processing of generating the PWM signal. Thus, the pump motor 210 is driven under control of the pump motor 210. At this time, the pump inverter 220 has a power consumption to which a power consumption by operation of the motor drive unit 221 to drive the pump motor 210 is added, and the power consumption has a magnitude expressed in units of several A, for example.

When the ignition switch 5 is turned from on to off (timing T3), the driving inverter 120 starts the after-run control.

When a predetermined period elapses after the after-run control is started (timing T4), the driving inverter 120 finishes the after-run control to finish the transmission of the drive command signal. The pump inverter 220 is configured such that although the signal detection unit 223 detects the end of reception of the drive command signal, a predetermined time is required to turn off the electric path opening-closing unit 224. Although the control unit 222 is in the ON state, where it is operable, until a predetermined time elapses, the end of reception of the drive command signal causes the processing of generating the PWM signal to be finished. Thus, the pump motor 210 is stopped. At this time, the pump inverter 220 has a power consumption having a magnitude expressed in units of several mA, for example, because the motor drive unit 221 finishes operation of driving the pump motor 210.

The pump inverter 220 is configured such that when the transmission of the drive command signal is finished and a predetermined time elapses (timing T5), the electric path opening-closing unit 224 is turned off to finish the power supply to the motor drive unit 221 and the control unit 222. No power supply causes the control unit 222 to fall in the OFF state where it is inoperable. At this time, the pump inverter 220 has a power consumption having a magnitude expressed in units of several μA, for example, because the control unit 222 finishes the operation.

As described above, when the reception of the drive command signal transmitted from the driving inverter 120 is finished, the pump inverter 220 according to the present preferred embodiment transitions to the operation state in which the control unit 222 is stopped to suppress the power consumption of the pump inverter 220. Thus, the present preferred embodiment enables suppressing the dark current of the pump inverter 220 that controls the pump motor 210 that drives the electric oil pump 200.

The actuator inverter 320 of the electric actuator also performs operation as with the pump inverter 220 of the electric oil pump 200.

Features of the present invention are listed below. The motor unit 1 of the present preferred embodiment includes the drive motor 110 that drives an electric vehicle. The motor unit 1 includes the pump motor 210 that drives the electric oil pump 200. The motor unit 1 includes the actuator motor 310 that drives the electric actuator 300. The motor unit 1 includes the driving inverter 120 that controls the drive motor 110 in response to the control signal transmitted from the vehicle control unit 2 of the electric vehicle. The motor unit 1 includes the pump inverter 220 that controls the pump motor 210 in response to the drive command signal transmitted from the driving inverter 120. The motor unit 1 includes the actuator inverter 320 that controls the actuator motor 310 in response to the drive command signal transmitted from the driving inverter 120. Then, when the reception of the drive command signal is finished, the pump inverter 220 transitions to the operation state of suppressing power consumption of the pump inverter 220. Similarly, when the reception of the drive command signal is finished, the actuator inverter 320 transitions to the operation state of suppressing power consumption of the actuator inverter 320.

The driving inverter 120 in the motor unit 1 of the present preferred embodiment finishes the transmission of the drive command signal in response to the control signal transmitted from the vehicle control unit 2.

The driving inverter 120 in the motor unit 1 of the present preferred embodiment finishes the transmission of the drive command signal, when a predetermined time elapses, in response to the control signal transmitted from the vehicle control unit 2.

The pump inverter 220 in the motor unit 1 of the present preferred embodiment includes the motor control unit 221 that drives the pump motor 210. The pump inverter 220 includes the control unit 222 that controls the motor drive unit 221. The pump inverter 220 includes the signal detection unit 223 that detects whether the drive command signal is received. The pump inverter 220 includes the electric path opening-closing unit 224 that switches on and off of the electric path for supplying electric power to the motor drive unit 221 and the control unit 222.

The electric path opening-closing unit 224 in the motor unit 1 of the present preferred embodiment is switched from on to off when the signal detection unit 223 detects the end of reception of the drive command signal.

The electric path opening-closing unit 224 in the motor unit 1 of the present preferred embodiment is turned off when the reception of the drive command signal is finished and a predetermined time elapses.

Similarly, the actuator inverter 320 in the motor unit 1 of the present preferred embodiment includes the motor drive unit that drives the actuator motor. The actuator inverter 320 includes the control unit that controls the motor drive unit. The actuator inverter 320 includes the signal detection unit that detects whether the drive command signal is received. The actuator inverter 320 includes the electric path opening-closing unit that switches on and off of the electric path for supplying electric power to the motor drive unit and the control unit.

The electric path opening-closing unit of the actuator inverter 320 in the motor unit 1 of the present preferred embodiment is switched from on to off when the signal detection unit detects an end of transmission of the drive command signal.

The electric path opening-closing unit of the actuator inverter 320 in the motor unit 1 of the present preferred embodiment is turned off when the transmission of the drive command signal is finished and a predetermined time elapses.

A motor control system 10 of the present preferred embodiment controls the drive motor 110, the pump motor 210, and the actuator motor 310. The motor control system 10 includes the driving inverter 120 that controls the drive motor 110 in response to the control signal transmitted from the vehicle control unit 2 of the electric vehicle. The motor control system 10 includes the pump inverter 220 that controls the pump motor 210 in response to the drive command signal transmitted from the driving inverter 120. The motor control system 10 includes the actuator inverter 320 that controls the actuator motor 310 in response to the drive command signal transmitted from the driving inverter 120. Then, when the reception of the drive command signal is finished, the pump inverter 220 transitions to the operation state of suppressing power consumption of the pump inverter 220. Similarly, when the reception of the drive command signal is finished, the actuator inverter 320 transitions to the operation state of suppressing power consumption of the actuator inverter 320.

The driving inverter 120 in the motor control system 10 of the present preferred embodiment finishes the transmission of the drive command signal in response to the control signal transmitted from the vehicle control unit 2.

The driving inverter 120 in the motor control system 10 of the present preferred embodiment finishes the transmission of the drive command signal, when a predetermined time elapses, in response to the control signal transmitted from the vehicle control unit 2.

The pump inverter 220 in the motor control system 10 of the present preferred embodiment includes the motor control unit 221 that drives the pump motor 210. The pump inverter 220 includes the control unit 222 that controls the motor drive unit 221. The pump inverter 220 includes the signal detection unit 223 that detects whether the drive command signal is received. The pump inverter 220 includes the electric path opening-closing unit 224 that switches on and off of the electric path for supplying electric power to the motor drive unit 221 and the control unit 222.

The electric path opening-closing unit 224 in the motor control system 10 of the present preferred embodiment is switched from on to off when the signal detection unit 223 detects the end of reception of the drive command signal.

The electric path opening-closing unit 224 in the motor control system 10 of the present preferred embodiment is turned off when the reception of the drive command signal is finished and a predetermined time elapses.

Similarly, the actuator inverter 320 in the motor control system 10 of the present preferred embodiment includes the motor drive unit that drives the actuator motor. The actuator inverter 320 includes the control unit that controls the motor drive unit. The actuator inverter 320 includes the signal detection unit that detects whether the drive command signal is received. The actuator inverter 320 includes the electric path opening-closing unit that switches on and off of the electric path for supplying electric power to the motor drive unit and the control unit.

The electric path opening-closing unit of the actuator inverter 320 in the motor control system 10 of the present preferred embodiment is switched from on to off when the signal detection unit detects an end of transmission of the drive command signal.

The electric path opening-closing unit of the actuator inverter 320 in the motor control system 10 of the present preferred embodiment is turned off when the transmission of the drive command signal is finished and a predetermined time elapses.

Although the present invention is described using the preferred embodiment, the technical scope of the present invention is not limited to the scope described in the above preferred embodiment. It is apparent to those skilled in the art that various modifications or improvements can be made to the above preferred embodiment. It is apparent from the description of the claims that a mode to which such a change or improvement is added can also be included in the technical scope of the present invention.

In the above preferred embodiment, the secondary battery type electric vehicle is described as an example of the “vehicle”. However, the “vehicle” is not limited to the secondary battery type electric vehicle as long as a drive motor is provided. The “vehicle” may be, for example, a hydrogen fuel cell vehicle in which hydrogen is stored in a fuel tank and power is generated by a hydrogen fuel cell to drive a drive motor. The “vehicle” may be, for example, a metal fuel cell vehicle in which a drive motor is driven by using a metal-air battery. The “vehicle” may be, for example, an alcohol fuel electromagnetic vehicle that stores alcohol in a fuel tank and travels using power generated by a fuel cell. The “vehicle” may be, for example, a trolley bus capable of not only traveling with a drive motor by collecting power from an overhead train line on a trunk line provided with an overhead line while charging a secondary battery, but also traveling as a battery type electric vehicle on a branch line without an overhead line. The “vehicle” may be, for example, an intermittent power supply electric vehicle in which power generated during braking that occurs during traveling is charged and the power is discharged at a subsequent startup. The “vehicle” may be, for example, a non-contact charging vehicle that can be powered and charged during traveling, from an underground cable buried under a road, without contact using electromagnetic induction and a resonance phenomenon. The “vehicle” may be a modified electric vehicle equipped with a drive motor and a battery, the modified electric vehicle being acquired by removing an engine, a muffler, a fuel tank, and the like from a gasoline engine or diesel engine vehicle.

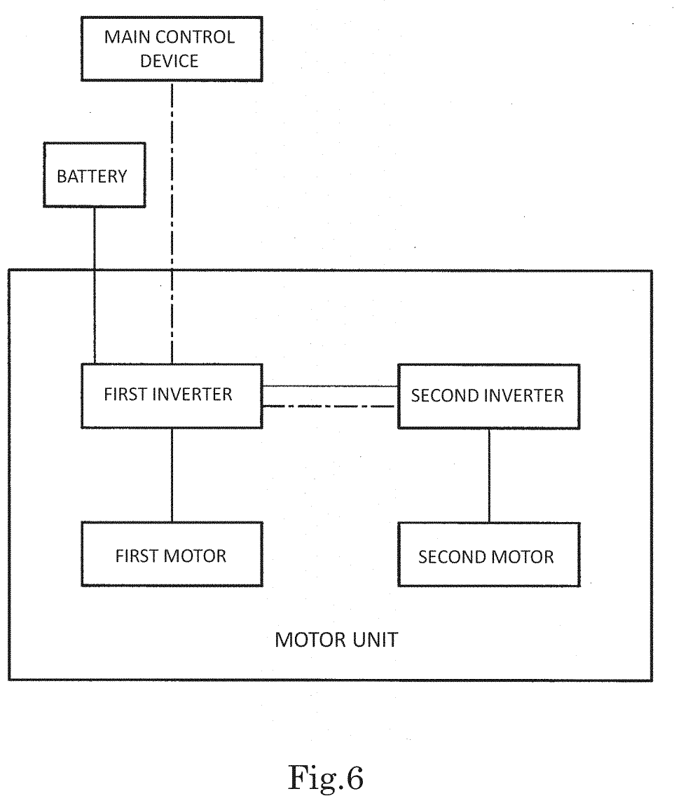

In the above preferred embodiment, the motor unit 1 including the drive motor 110 as the “first motor”, and the pump motor 210 and the actuator motor 310 each as the “second motor”, is described as an example. The motor unit 1 including the driving inverter 120 as the “first inverter”, and the pump inverter 220 and the actuator inverter 320 each as the “second inverter”, is described as an example. However, the “motor unit” only has to include the “first motor”, and the “second motor” that drives an auxiliary machine of the “first motor”, as shown in FIG. 6. As shown in FIG. 6, the “motor unit” only has to include the “first inverter” that controls the “first motor” in response to the control signal transmitted from a “main control device” of the vehicle. As shown in FIG. 6, the “motor unit” only has to include the “second inverter” that controls the “second motor” in response to the drive command signal for driving the “second motor” transmitted from the “first inverter”. For example, the “second motor” may be a clutch motor, a transmission mechanism motor, a water pump motor, or the like.

It should be noted that an execution sequence of each processing such as operations, procedures, steps, and stages in the devices, systems, programs, and methods shown in the claims, the specification, and the drawings can be implemented in any order unless “before”, “prior to”, or the like is specifically stated and output of the previous processing is used in the later processing. Even when the term, “first”, “next”, or the like is used for convenience in description of the operation flow in the claims, the specification, and the drawings, the term does not mean that the operation flow is essentially performed in the order indicated by the term.

Features of the above-described preferred embodiments and the modifications thereof may be combined appropriately as long as no conflict arises.

While preferred embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

1. A motor unit comprising:
a first motor that drives a vehicle;
a second motor that drives an auxiliary machine of the first motor;
a first inverter that controls the first motor in response to a control signal transmitted from a main control device of the vehicle; and
a second inverter that controls the second motor in response to a drive command signal for controlling the second motor transmitted from the first inverter,
wherein the second inverter transitions to an operation state of suppressing power consumption of the second inverter when reception of the drive command signal is finished.

2. The motor unit according to claim 1, wherein the first inverter finishes transmission of the drive command signal in response to the control signal transmitted from the main control device.

3. The motor unit according to claim 2, wherein the first inverter finishes the transmission of the drive command signal, when a predetermined time elapses, in response the control signal transmitted from the main control device.

4. The motor unit according to claim 1, wherein
the second inverter includes
a motor drive unit that drives the second motor,
a control unit that controls the motor drive unit,
a signal detection unit that detects whether the drive command signal is received, and
an electric path opening-closing unit that switches on and off an electric path for supplying electric power to the motor drive unit and the control unit.

5. The motor unit according to claim 4, wherein the electric path opening-closing unit is switched from on to off when the signal detection unit detects an end of reception of the drive command signal.

6. The motor unit according to claim 5, wherein the electric path opening-closing unit is turned off when the reception of the drive command signal finishes and a predetermined time elapses.

7. The motor unit according to claim 1, wherein the auxiliary machine is an electric actuator of a parking lock mechanism or an electric oil pump.

8. A motor control system configured to control a first motor that drives a vehicle and a second motor that drives an auxiliary machine of the first motor, the motor control system comprising:
a first inverter that controls the first motor in response to a control signal transmitted from a main control device of the vehicle; and
a second inverter that controls the second motor in response to a drive command signal transmitted from the first inverter for controlling the second motor,
wherein the second inverter transitions to an operation state of suppressing power consumption of the second inverter when reception of the drive command signal is finished.
